(19) United States
(12) Patent Application Publication
(10) Pub. No.: US 2015/0259154 A1
(43) Pub. Date: Sep. 17, 2015

(54) TRANSPORTING MECHANISM

(71) Applicants: SHENZHEN FUTAIHONG PRECISION INDUSTRY CO., LTD., Shenzhen (CN); FIH (HONG KONG) LIMITED, Kowloon (HK)

(72) Inventors: JIE GAO, Shenzhen (CN); BING YU, Shenzhen (CN); JIAN-PING JIN, Shenzhen (CN)

(21) Appl. No.: 14/574,045

(22) Filed: Dec. 17, 2014

(30) Foreign Application Priority Data
Mar. 17, 2014 (CN) 201410096752.2

(51) Int. Cl. B65G 41/00; B65G 17/00

(52) U.S. Cl. CPC B65G 41/006; B65G 17/002

(57) ABSTRACT

A transporting mechanism includes a transporting assembly, a slave assembly, a driving assembly, and a transferring assembly. The transporting assembly includes a base plate, two side plates extended from the base plate, two parallel fixed sliding rails correspondingly positioned on the side plates, two movable sliding rails, a number of sliding blocks, and a transporting belt. Each fixed sliding rail includes a first end and a second end opposite to the first end. The transporting belt engages with the plurality of sliding blocks. The slave assembly and the driving assembly are positioned at two ends of the base plate and engage with the transporting belt. The driving assembly drives the transporting belt to carry the number of sliding blocks to slide along the fixed sliding rails. The transferring assembly and the slave assembly transfer the number of sliding blocks between the fixed sliding rails.

### FIELD

The subject matter herein generally relates to transporting mechanisms, and particularly to a transporting mechanism used to automatically transport work pieces between two parallel rails.

### BACKGROUND

During manufacturing, work pieces are commonly transported by two parallel rails for different manufacturing processes such as assembly. To save work space, two parallel rails are often employed to transport the work pieces.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of a transporting mechanism, according to an exemplary embodiment.

FIG. 2 is an exploded, partial view of the transporting mechanism of FIG. 1.

FIG. 3 is a cross-sectional view of the transporting mechanism of FIG. 1 along line III-III.

FIG. 4 is an exploded view of a driving assembly and a transporting assembly of the transporting mechanism of FIG. 1.

FIG. 5 is a cross-sectional view of the transporting mechanism of FIG. 1 along line V-V.

FIG. 6 is an exploded view of a slave assembly of the transporting mechanism of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

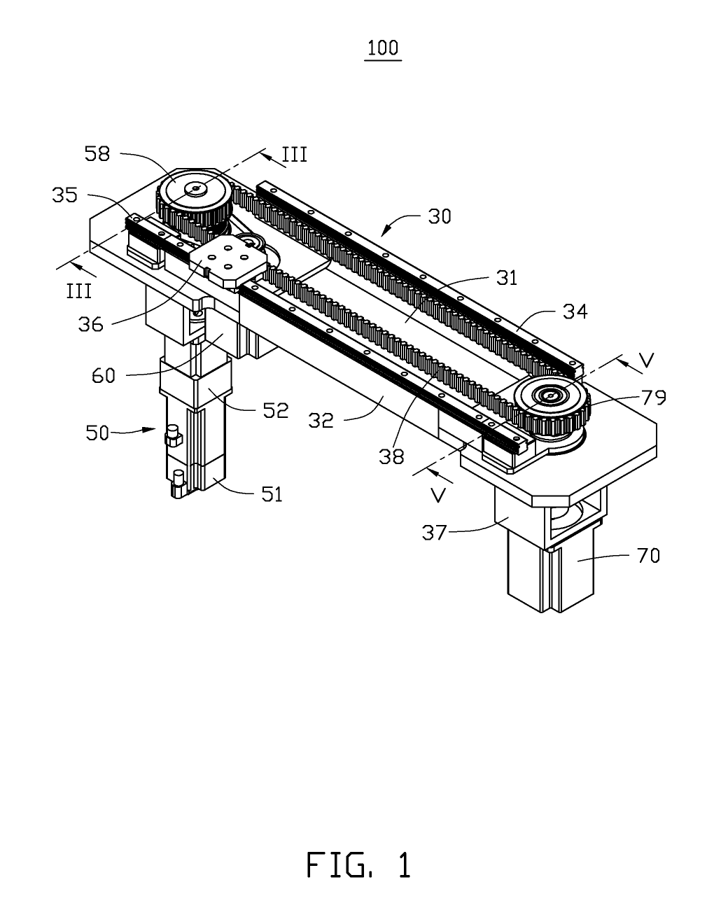

FIG. 1 is an isometric view of a transporting mechanism 100, according to an exemplary embodiment. The transporting mechanism 100 is configured to transfer work pieces between two parallel sliding rails such as fixed sliding rails 34. The transporting mechanism 100 includes a transporting assembly 30, a driving assembly 50, a transferring assembly 60, and a slave assembly 70.

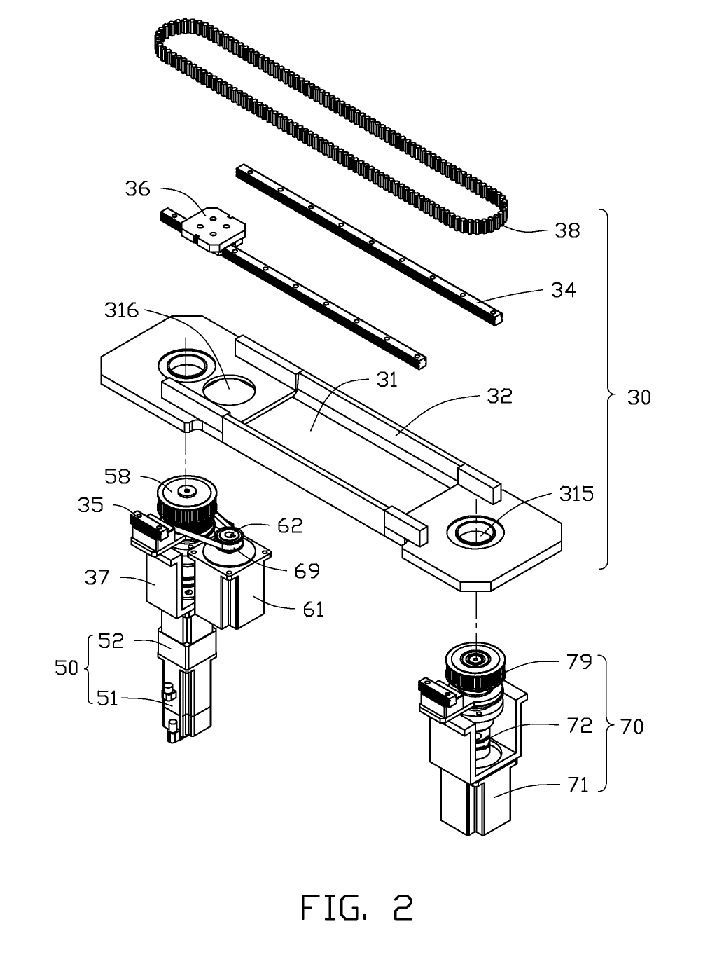

The transporting assembly 30 is configured for transporting the work pieces. FIG. 2 illustrates that the transporting assembly 30 includes a base plate 31, two opposite side plates 32, two fixed sliding rails 34, two movable sliding rails 35, a plurality of sliding blocks 36, two supporters 37, and a transporting belt 38.

Two first receiving holes 315 are defined at two ends of the base plate 31. A second receiving hole 316 is defined in the base plate 31 adjacent to one of the first receiving holes 315. The two side plates 32 are perpendicularly extended from one side of the base plate 31. The two fixed sliding rails 34 are fixed on the side plates 32, respectively. Each fixed sliding rail 34 includes a first end and a second end opposite to the first end. The two movable sliding rails 35 are mounted to the transferring assembly 60 and the slave assembly 70, respectively. One of the movable sliding rails 35 can be driven to rotate from the first end of one of the fixed sliding rails 34 to the first end of another fixed sliding rail 34. Another movable sliding rail 35 can be rotated from the second end of one of the fixed sliding rails 34 to the second end of another fixed sliding rail 34. The sliding blocks 36 engages with the transporting belt 38 so that the sliding blocks 36 can be moved with the transporting belt 38 to slide along the fixed sliding rails 34 or rotate from one fixed sliding rail 34 to another fixed sliding rail 34 with the movable sliding rails 35. The supporters 37 are configured for securing the driving assembly 50 and the slave assembly 70. The supporters 37 are fixed to a side of the base plate 31 opposite to the side plates 32 and aligning with the first receiving holes 315. The transporting belt 38 engages with the driving assembly 50 and the slave assembly 70.

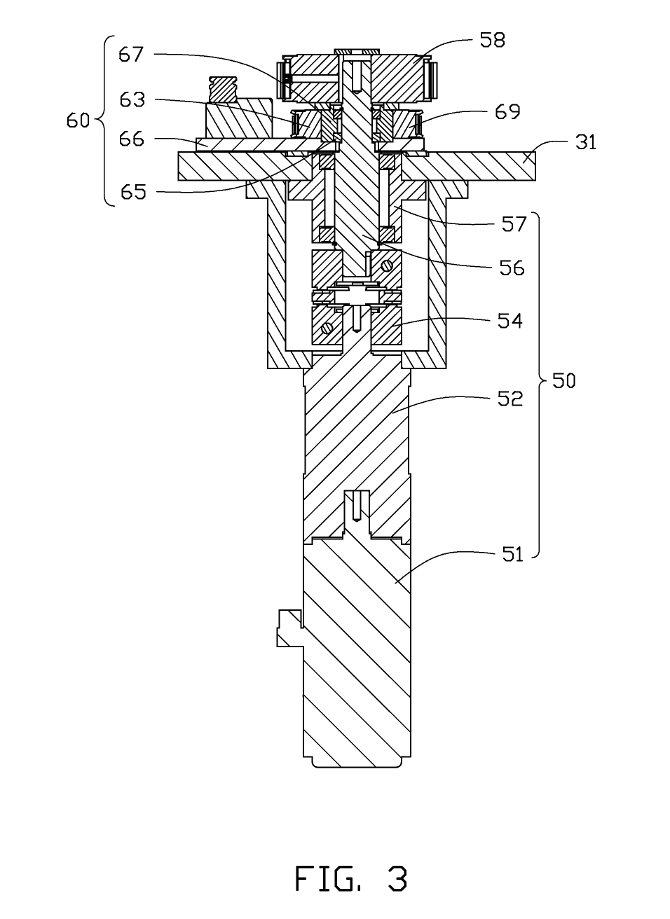

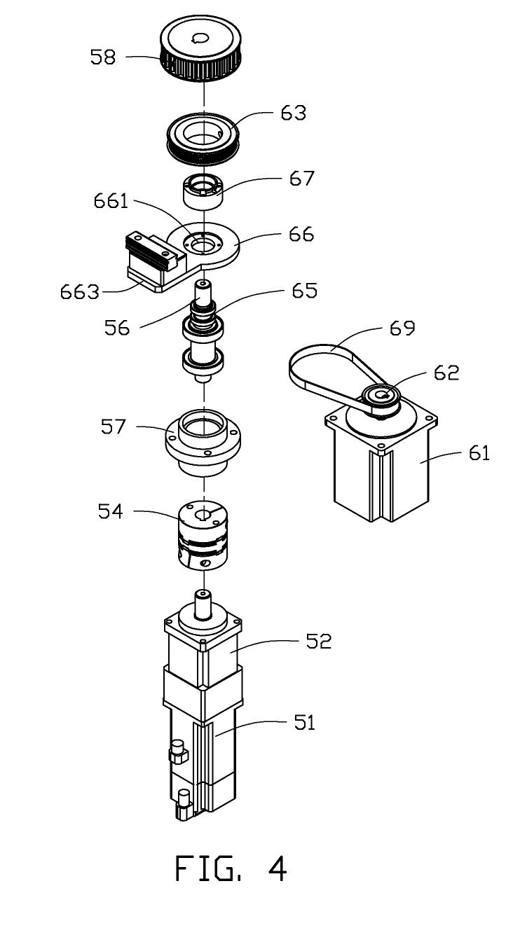

The driving assembly 50 is configured for driving the transmission assembly 30. FIGS. 3 and 4 illustrate that the driving assembly 50 includes a first motor 51, a first reducer 52, a first coupler 54, a first rod 56, a first bearing 57, and a primary driving wheel 58.

The first motor 51 is configured for driving the first rod 56 to rotate. The reducer 52 is secured on the first motor 51 for adjusting a rotating speed of the first motor 51 and assembled to an end of one of the supporters 37. The first rod 56 is extended through and partially received in one of the first receiving holes 315 with two ends of the first rod 56 exposed from the first receiving holes 315. One end of the first rod 56 is connected to the first reducer 52 by the first coupler 54. The first bearing 57 is rotatably sleeved around the first rod 56 and positioned at one side of the base plate 31 opposite to the side plates 32. The first bearing 57 is partially received in one of the first receiving holes 315 and secured to the base plate 31. The primary driving wheel 58 is sleeved around another end of the first rod 56 and is capable of rotating with the first rod 56.

The transferring assembly 60 is configured for transferring the work pieces between the two fixed sliding rails 34. The transferring assembly 60 includes a second motor 61, a secondary driving wheel 62, a secondary slave wheel 63, a second bearing 65, a first transferring member 66, a sleeve 67, and a driving belt 69.

The second motor 61 is fixedly received in the second receiving hole 316 and configured for driving the secondary driving wheel 62. The second driving wheel 62 is secured on the second motor 61. The second slave wheel 63 is sleeved around the second bearing 65. The second bearing 65 is rotatably sleeved around the first rod 56 and positioned between the first bearing 57 and the primary driving wheel 58. The first transferring member 66 is substantially a plate. A mounting hole 661 is defined in the first transferring member 66. The transferring member 66 further includes an extending portion 663 protruding from an end of the transferring member 66. One of the movable sliding rails 35 is positioned on the extending portion 663. The first transferring member 66 is sleeved around the first rod 56 through the mounting hole 661 and positioned on the base plate 31. The sleeve 67 is sleeved around the first rod 56 and positioned between the secondary slave wheel 63 and the second bearing 65. The first transferring member 66 is secured to the sleeve 67 and capable of rotating with the secondary slave wheel 63. The driving belt 69 is configured for driving the secondary slave wheel 63 to rotate with the secondary driving wheel 62. An end of the driving belt 69 is sleeved around the secondary driving wheel 62. Another end of the driving belt 69 is sleeved around the secondary slave wheel 63.

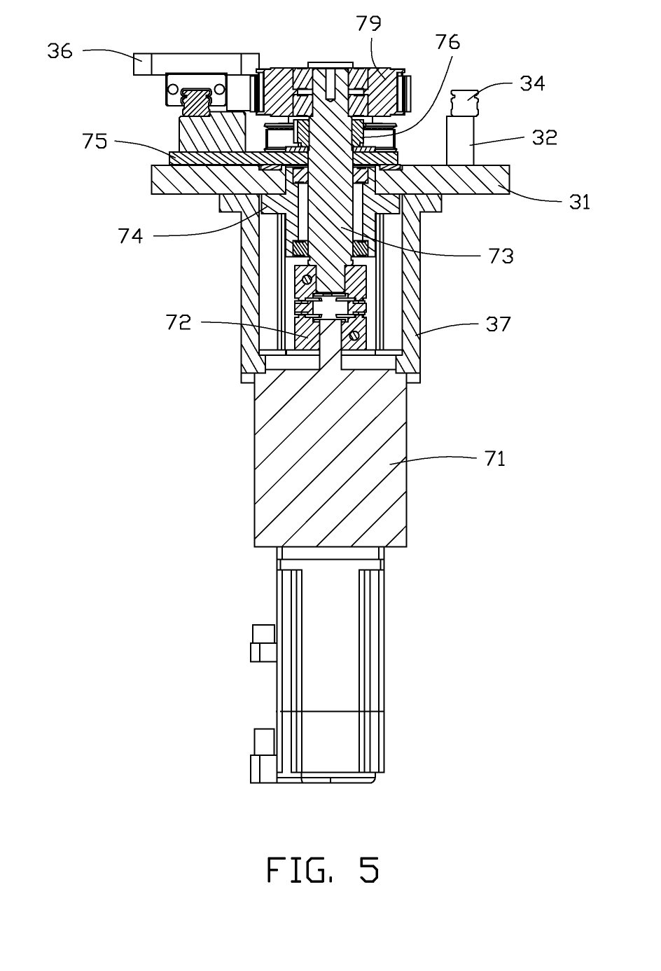

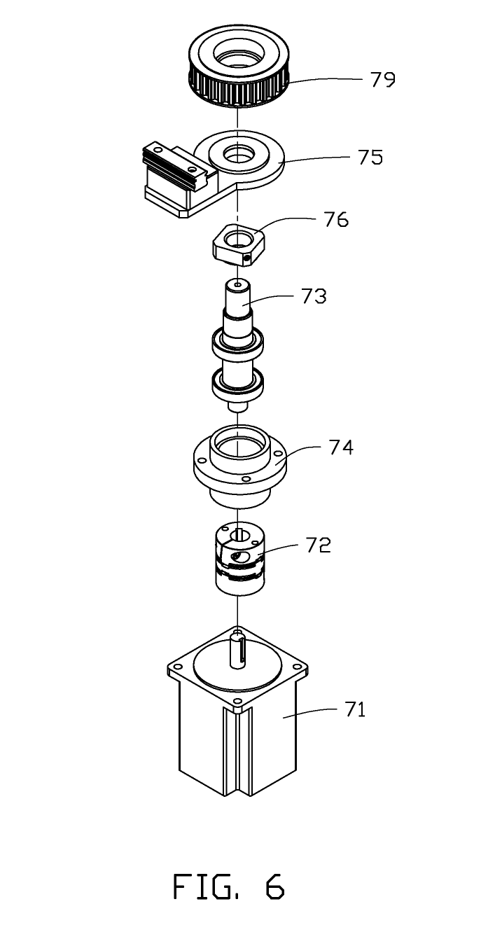

FIGS. 5 and 6 illustrate the slave assembly 70 includes a third motor 71, a second coupler 72, a second rod 73, a third bearing 74, a second transferring member 75, a fastener 76, and a primary slave wheel 79.

The third motor 71 is secured to the base plate 37 through another supporter 37 and configured for driving the second rod 73 to rotate. The second rod 73 is extended through and partially received in another first receiving hole 315 with two ends of the second rod 73 exposed from another first receiving hole 315. One end of the second rod 73 is connected to the third motor 71 by the second coupler 72. The second bearing 74 is rotatably sleeved around the second rod 73 and positioned at one side of the base plate 31 opposite to the side plates 32. The second bearing 74 is partially received in the another first receiving hole 315 and secured to the base plate 31. The structure of second transferring member 75 is similar to that the first transferring member 66, and therefore is not detailed. The second transferring member 75 is sleeved around the second rod 73 with another movable sliding rail 35 and capable of rotating with the second rod 73. The fastener 76 is sleeved around the second rod 731 and locked the second transferring member 75 to prevent the second transferring member 75 from rotating relative to the second rod 73. The primary slave wheel 79 is sleeved around another end of the second rod 73 adjacent to the fastener 76 and capable of rotating with the primary driving wheel 58 through the transporting belt 38.

In use, the work pieces are fixed on the sliding blocks 36. In an initial position, one of the movable sliding rails 35 assembled to the first transferring member 66 is docked with (i.e. collinear with) the first end of one of the fixed sliding rails 34 (as shown in FIG. 1). Another movable sliding rail 35 assembled to the second transferring member 75 is docked with the second end of another fixed sliding rail 34. The first motor 51 starts to work and drives the primary driving wheel 58 to rotate. The primary slave wheel 79 is rotated with the primary driving wheel 58. The transporting belt 38 carries the sliding blocks 36 to slide along the fixed sliding rails 34. When one of the sliding blocks 36 is slid from the first end of one of the fixed sliding rails 34 to the corresponding movable sliding rail 35, the second motor 61 starts to work and drives the secondary driving wheel 62 to rotate. The secondary slave wheel 63 is rotated with the secondary driving wheel 62 so that the first transferring member 66 is rotated relative to the first rod 56. The first motor 51 can be adjusted to keep pace with the second motor 61 so that the sliding block 36 is rotated with the first transferring member 66 until the first transferring member 66 arrives at the first end of another fixed sliding rail 34. The sliding block 36 is slid from the movable sliding rail 35 to the first end of another fixed sliding rail 34. Therefore, the sliding block 36 fixed with the work piece is transferred from the first end of one of fixed sliding rails 34 to the first end of another fixed sliding rail 34. The second motor 61 starts to drive the secondary driving wheel 62 to reversely rotate until the movable sliding rail 35 returns back to the initial position.

Meanwhile, when one of the sliding blocks 36 is slid from the second end of another fixed sliding rail 34 to the corresponding movable sliding rail 35, the third motor 71 starts to work and drives the second rod 73 to rotate. The second transferring member 75 is rotated with the second rod 73 until the second transferring member 75 arrives at the second end of one of the fixed sliding rails 34 (as shown in FIG. 1). The sliding block 36 is slid from the movable sliding rail 35 to the second end of one of the fixed sliding rails 34. Therefore, the sliding block 36 fixed with the work piece is transferred from the second end of another fixed sliding rail 34 to the second end of one of the fixed sliding rails 34. The third motor 71 starts to drive the second rod 73 to reversely rotate until the movable sliding rail 35 returns back to the initial position.

Because the transferring assembly 60 transfers the plurality of sliding blocks 36 from the first end of one of the fixed sliding rails 34 to the first end of another fixed sliding rail 34 and the slave assembly 70 transfers the plurality of sliding blocks 36 from the second end of one of fixed sliding rails 34 to the second end of another fixed sliding rail 34, the work pieces fixed on the sliding blocks 36 can be automatically and circularly transferred between the fixed sliding rails 34.

It is to be understood, however, that even through numerous characteristics and advantages of the present disclosure have been set forth in the foregoing description, together with details of assembly and function, the disclosure is illustrative only, and changes may be made in the details, especially in the matters of shape, size, and arrangement of parts within the principles of the disclosure to the full extent indicated by the broad general meaning of the terms in which the appended claims are expressed.

What is claimed is:

1. A transporting mechanism comprising:
a transporting assembly comprising:
a base plate;
two side plates extended from the base plate;
two parallel fixed sliding rails correspondingly positioned on the side plates, each fixed sliding rail comprising a first end and a second end opposite to the first end;
two movable sliding rails;
a plurality of sliding blocks; and
a transporting belt engaging with the plurality of sliding blocks;
a slave assembly and a driving assembly positioned at two ends of the base plate and engaging with the transporting belt, the driving assembly driving the transporting belt to carrying the plurality of sliding blocks to slide along the fixed sliding rails; and
a transferring assembly transferring the plurality of sliding blocks from the first end of one of the fixed sliding rails to the first end of another fixed sliding rail through one of the movable sliding rails, the slave assembly transferring the plurality of sliding blocks from the second end of one of fixed sliding rails to the second end of another fixed sliding rail through another movable sliding rail.

2. The transporting mechanism of claim 1, wherein the driving assembly comprises a first motor, a first rod, a first bearing, and a primary driving wheel; the first motor is configured for driving the first rod to rotate; the first rod is extended through the base plate with two ends of the first rod positioned at two sides of the base plate; one end of the first rod is secured to the first motor; the first bearing is rotatably sleeved around the first rod and secured on the base plate; the primary driving wheel is sleeved around another end of the first rod and rotated with the first rod.

3. The transporting mechanism of claim 2, wherein the transferring assembly comprises a second motor assembled to the base plate, a secondary driving wheel secured on the second motor, a secondary slave wheel, a second bearing, a first transferring member, and a driving belt; the second bearing is sleeved around the first rod and positioned between the first bearing and the primary driving wheel, the second slave wheel is sleeved around the second bearing, the first transferring member is sleeved around the first rod and capable of rotating with the secondary slave wheel, an end of the driving belt is sleeved around the secondary driving wheel, another end of the driving belt is sleeved around the secondary slave wheel.

4. The transporting mechanism of claim 3, wherein the first transferring member defines a mounting hole, the first transferring member is sleeved around the first rod through the mounting hole, the first transferring member comprises an extending portion protruding from an end of the transferring member, one of the movable sliding rails is positioned on the extending portion.

5. The transporting mechanism of claim 3, wherein the transferring assembly further comprises a sleeve sleeved around the first rod and positioned between the secondary slave wheel and the second bearing, the first transferring member is secured to the sleeve.

6. The transporting mechanism of claim 2, wherein the slave assembly comprises a third motor, a second rod, a third bearing, a second transferring member, and a primary slave wheel; the third motor is configured for driving the second rod to rotate, the second rod is extended through the base plate with two ends of the second rod positioned at two sides of the base plate; one end of the second rod is secured to the third motor, a second bearing is rotatably sleeved around the second rod and secured on the base plate; the second transferring member is sleeved around the second rod and capable of rotating with the second rod; the primary slave wheel is sleeved around another end of the first rod and rotated with the primary driving wheel.

7. The transporting mechanism of claim 6, wherein the slave assembly further comprises a fastener sleeved around the second rod and locked the second transferring member to prevent the second transferring member to rotate relative to the second rod.

8. A transporting mechanism comprising:
a transporting assembly comprising:
a base plate;
two side plates extended from the base plate;
two parallel fixed sliding rails correspondingly positioned on the side plates;
a movable sliding rail;
a plurality of sliding blocks; and
a transporting belt engaging with the plurality of sliding blocks;
a slave assembly and a driving assembly positioned at two ends of the base plate and engaging with the transporting belt, the driving assembly driving the transporting belt to carrying the plurality of sliding blocks to slide along the fixed sliding rails; and
a transferring assembly transferring the plurality of sliding blocks from one of the fixed sliding rails to another fixed sliding rail through the movable sliding rail.

9. The transporting mechanism of claim 8, wherein the driving assembly comprises a first motor, a first rod, a first bearing, and a primary driving wheel; the first motor is configured for driving the first rod to rotate; the first rod is extended through the base plate with two ends of the first rod positioned at two sides of the base plate; one end of the first rod is secured to the first motor; the first bearing is rotatably sleeved around the first rod and secured on the base plate; the primary driving wheel is sleeved around another end of the first rod and rotated with the first rod.

10. The transporting mechanism of claim 9, wherein the transferring assembly comprises a second motor assembled to the base plate, a secondary driving wheel secured on the second motor, a secondary slave wheel, a second bearing, a transferring member, and a driving belt; the second bearing is sleeved around the first rod and positioned between the first bearing and the primary driving wheel, the second slave wheel is sleeved around the second bearing, the transferring member is sleeved around the first rod and capable of rotating with the secondary slave wheel, an end of the driving belt is sleeved around the secondary driving wheel, another end of the driving belt is sleeved around the secondary slave wheel.

11. The transporting mechanism of claim 10, wherein the first transferring member defines a mounting hole, the transferring member is sleeved around the first rod through the mounting hole, the transferring member comprises an extending portion protruding from an end of the transferring member, the movable sliding rails is positioned on the extending portion.

12. The transporting mechanism of claim 10, wherein the transferring assembly further comprises a sleeve sleeved around the first rod and positioned between the secondary slave wheel and the second bearing, the first transferring member is secured to the sleeve.

13. The transporting mechanism of claim 9, wherein the slave assembly comprises a second rod secured on the base plate and a primary slave wheel, the primary slave wheel is sleeved around an end of the first rod and rotated with the primary driving wheel.

14. A transporting mechanism comprising:
a transporting assembly comprising:
a base plate;
two side plates extended from the base plate;
two parallel fixed sliding rails correspondingly positioned on the side plates;
a movable sliding rails;
a plurality of sliding blocks; and
a transporting belt engaging with the plurality of sliding blocks;
a slave assembly and a driving assembly positioned at two ends of the base plate and engaging with the transporting belt, the driving assembly driving the transporting belt to carrying the plurality of sliding blocks to slide along the fixed sliding rails, the slave assembly transferring the plurality of sliding blocks from one of the fixed sliding rails to another movable sliding rail through the movable sliding rail.

15. The transporting mechanism of claim 14, wherein the driving assembly comprises a first motor, a first rod, a first bearing, and a primary driving wheel; the first motor is configured for driving the first rod to rotate; the first rod is extended through the base plate with two ends of the first rod positioned at two sides of the base plate; one end of the first rod is secured to the first motor; the first bearing is rotatably sleeved around the first rod and secured on the base plate; the primary driving wheel is sleeved around another end of the first rod and rotated with the first rod.

16. The transporting mechanism of claim 15, wherein the slave assembly comprises a second motor, a second rod, a second bearing, a transferring member, and a primary slave wheel; the second motor is configured for driving the second rod to rotate, the second rod is extended through the base plate with two ends of the second rod positioned at two sides of the base plate; one end of the second rod is secured to the second motor, the second bearing is rotatably sleeved around the second rod and secured on the base plate; the transferring member is sleeved around the second rod and capable of rotating with the second rod; the primary slave wheel is sleeved around another end of the first rod and rotated with the primary driving wheel.

17. The transporting mechanism of claim 16, wherein the slave assembly further comprises a fastener sleeved around the second rod and locked the transferring member to prevent the transferring member to rotate relative to the second rod.

18. The transporting mechanism of claim 16, wherein the first transferring member defines a mounting hole, the transferring member is sleeved around the second rod through the mounting hole, the transferring member comprises an extending portion protruding from an end of the transferring member, the movable sliding rails is positioned on the extending portion.
